(19) United States
(12) Patent Application Publication
(10) Pub. No.: US 2017/0289337 A1
(43) Pub. Date: Oct. 5, 2017

(54) Faster Text Entry on Mobile Devices Through User-Defined Stroke Patterns

(71) Applicant: Google Inc., Mountain View, CA (US)

(72) Inventors: Li-Lun Wang, Sunnyvale, CA (US); Victor Carbune, Basel (CH); Dhyanesh Narayanan, Sunnyvale, CA (US); Henry Rowley, Sunnyvale, CA (US); Thomas Deselaers, Zurich (CH)

(21) Appl. No.: 15/090,836

(22) Filed: Apr. 5, 2016

(51) Int. Cl. H04M 1/725; G06N 3/08; G06F 3/0488; G06F 3/0484; G06F 17/24

(52) U.S. Cl. CPC H04M 1/72552; G06F 3/0484; G06F 17/243; G06F 3/04883; G06N 3/08

(57) ABSTRACT

The present disclosure provides systems and methods for text entry through handwritten shorthand stroke patterns. One example computer-implemented method includes receiving, by a mobile computing device, data descriptive of an input stroke pattern entered by a user. The input stroke pattern includes one or more strokes that approximate a non-linguistic symbol. The method includes identifying, by the mobile computing devices, one of a plurality of shorthand stroke patterns as a matched shorthand pattern to which the input stroke pattern corresponds. The plurality of shorthand stroke patterns have been previously defined by the user. A plurality of output text strings are respectively associated with the plurality of shorthand stroke patterns. The method further includes, in response to identifying the matched shorthand pattern, entering, by the mobile computing device, the output text string associated with the matched shorthand pattern into a text entry field.

### FIELD

The present disclosure relates generally to text entry on mobile devices and, more particularly, to faster text entry on mobile devices through the use of handwritten shorthand stroke patterns defined by the user.

### BACKGROUND

Text entry on mobile devices is still a relatively challenging and frustrating experience for the user. As one example, many mobile devices (e.g., smartphones, tablets, etc.) include a touch-sensitive display screen. As such, a user typically performs text entry by way of an on-screen keyboard in which respective portions of the touch-sensitive screen correspond to keys of the keyboard (also known as a “soft keyboard”). However, due to the limited size of the portion of the display screen used to display the on-screen keyboard, the keys of the on-screen keyboard are relatively small and can be challenging to individually select. This causes text entry to be challenging and results in a relative increase in spelling errors or other mistakes, as a user may intend to press a first key but instead select a second key. A lack of tactile feedback can also contribute to this problem.

Further, although many devices include some form of automatic spelling correction, in some instances such automatic spelling correction can be as frustrating as it is useful. In particular, the automatic spelling correction may undesirably “correct” a certain word entered by the user to a more common word, counter to the intention of the user.

One alternative to on-screen keyboards is the use of voice input to enter text. For example, a user can dictate a sentence or phrase that she wishes to enter into the device and the device will recognize the spoken phrase and enter the corresponding text. However, processing of the received voice signal can require an undesirable amount of time, leading to large pauses between speech and text entry. Such is particularly true if the received voice signal must be uploaded to a server computing device for recognition. Further, the spoken phrase may be incorrectly recognized, leading to phrasing errors, punctuation errors, or incorrect wording.

Another alternative to on-screen keyboards is the use of handwriting recognition to enter text. For example, a user can use a finger or stylus to “write” letters or words of a language on the screen or other touch-sensitive component. The device will recognize the written letters or words and enter the corresponding text. However, entry of text via handwriting recognition can require an undesirable amount of time, as the user is required to separately write each word they wish to enter. Further, due to the limited size of the display screen on which the user can write, the user may struggle to write more than a single word at a time within such space, leading to pauses between words and adding to the amount of time required to handwrite the text.

As another drawback of handwriting recognition, it may be difficult for a user to fit the entirety of a longer word within the space for writing, which can lead to a scenario where the user writes only a first portion of a word within the space, runs out of room, and then waits for the screen to clear to write the second portion of the word. This scenario can also result in processing or recognition errors, as the device may attempt to recognize (and potentially autocorrect) only the first portion of the word before receiving the second portion of the word.

Thus, the entry of text into a mobile computing device by a user is still a frustrating experience and unsolved problem. As such, users may opt to use a device with a traditional keyboard (e.g., laptop computer or desktop computer) in lieu of their mobile device when entering a significant amount of text (e.g., writing an email) or when attempting to reduce typographical errors so as to appear professional. Further, even when entering text for purely conversation purposes (e.g., a casual text message), a user may be frustrated by having to repeatedly type longer sentences into the mobile device using the on-screen keyboard, for the reasons discussed above.

Therefore, systems and methods that enable faster and error-free text entry for mobile devices are desired.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for text entry through handwritten shorthand stroke patterns. The method includes receiving, by a mobile computing device, data descriptive of an input stroke pattern entered by a user. The input stroke pattern includes one or more strokes that approximate a non-linguistic symbol. The method includes identifying, by the mobile computing devices, one of a plurality of shorthand stroke patterns as a matched shorthand pattern to which the input stroke pattern corresponds. The plurality of shorthand stroke patterns have been previously defined by the user. A plurality of output text strings are respectively associated with the plurality of shorthand stroke patterns. The method further includes, in response to identifying the matched shorthand pattern, entering, by the mobile computing device, the output text string associated with the matched shorthand pattern into a text entry field of the mobile computing device.

Another example aspect of the present disclosure is directed to a mobile computing device that enables text entry through shorthand stroke patterns. The mobile computing device includes at least one processor and at least one non-transitory computer-readable medium that stores: data that describes a plurality of shorthand stroke patterns that have previously been defined by a user of the mobile computing device; and a plurality of output text strings respectively associated with the plurality of shorthand stroke patterns. The mobile computing device includes a shorthand pattern recognizer implemented by the at least one processor. The shorthand pattern recognizer is configured to: receive data that describes an input stroke pattern entered by the user; and identify one of the plurality of shorthand stroke patterns as a matched shorthand stroke pattern to which the input stroke pattern corresponds. In response to identification of the matched shorthand stroke pattern by the shorthand pattern recognizer, the mobile computing device is configured to enter the output text string associated with the matched shorthand stroke pattern into a text entry field.

Another example aspect of the present disclosure is directed to at least one non-transitory computer-readable medium that stores instructions that, when executed by at least one processor, cause the at least one processor to perform operation. Execution of the instructions causes the at least one processor to receive data descriptive of an input stroke pattern entered by a user. Execution of the instructions causes the at least one processor to input the data descriptive of the input stroke pattern into a shorthand pattern classifier. Execution of the instructions causes the at least one processor to receive as output from the shorthand pattern classifier an identification of one of a plurality of shorthand stroke patterns as a matched shorthand pattern to which the input stroke pattern corresponds. The plurality of shorthand stroke patterns have been previously defined by the user. A plurality of output text strings are respectively associated with the plurality of shorthand stroke patterns. Execution of the instructions causes the at least one processor to enter the output text string associated with the matched shorthand pattern into a text entry field in response to receiving the identification of the matched shorthand pattern.

Other aspects of the present disclosure are directed to systems, methods, apparatus, and tangible non-transitory computer-readable media for implementing one or more aspects described herein.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

FIGS. 1A-D depict text entry into an example mobile computing device through the use of a handwritten shorthand stroke pattern according to example embodiments of the present disclosure.

FIG. 2 depicts a block diagram an example computing system according to example embodiments of the present disclosure.

FIG. 3 depicts a graphical representation of a table that contains example user-defined shorthand stroke patterns and corresponding output text strings according to example embodiments of the present disclosure.

FIG. 4 depicts a block diagram of an example input recognizer according to example embodiments of the present disclosure.

FIG. 5 depicts a block diagram of an example input recognizer according to example embodiments of the present disclosure.

FIG. 6 depicts a block diagram of an example input recognizer according to example embodiments of the present disclosure.

FIG. 7 depicts a flow chart diagram of an example method for text entry through shorthand stroke patterns according to example embodiments of the present disclosure.

FIG. 8 depicts a flow chart diagram of an example method for text entry through shorthand stroke patterns according to example embodiments of the present disclosure.

FIG. 9 depicts a flow chart diagram of an example method for text entry through shorthand stroke patterns according to example embodiments of the present disclosure.

FIG. 10 depicts a flow chart diagram of an example method for text entry through shorthand stroke patterns according to example embodiments of the present disclosure.

FIG. 11 depicts a flow chart diagram of an example method for suggestion of shorthand stroke pattern creation according to example embodiments of the present disclosure.

FIG. 12 depicts a flow chart diagram of an example method for creation of a new shorthand stroke pattern according to example embodiments of the present disclosure.

### DETAILED DESCRIPTION

### Overview

Generally, the present disclosure provides systems and methods for text entry through handwritten shorthand stroke patterns. In particular, an example mobile computing device of the present disclosure enables a user to input or otherwise define a plurality of shorthand stroke patterns. Each shorthand stroke pattern can include a set of strokes drawn or otherwise entered by the user via a touch-sensitive component of the mobile computing device. For example, the user can draw on a touch-sensitive display of the mobile computing device using a finger or stylus. Further, the mobile computing device enables the user to associate a plurality of output text strings respectively with the plurality of shorthand stroke patterns. The output text strings can be, for example, certain longer sentences or phrases that the user commonly uses but does not wish to repeatedly manually type or enter. Thus, the mobile computing device can enable the user to create one or more custom shorthand stroke patterns which map to longer, commonly used text strings.

After creation of the custom shorthand stroke patterns, the example mobile computing device can receive data descriptive of an input stroke pattern entered by a user. The mobile computing device can identify one of the plurality of previously user-defined shorthand stroke patterns as a matched shorthand pattern to which the input stroke pattern corresponds. In response to identifying the matched shorthand pattern, the mobile computing device can enter the output text string associated with the matched shorthand pattern into a text entry field of the mobile computing device.

In such fashion, the user can obtain entry of the corresponding longer output text string by entering a stroke pattern which matches or otherwise corresponds to a previously user-defined shorthand stroke pattern. Thus, aspects of the present disclosure provide faster text entry through the use and recognition of any number of user-defined shorthand stroke patterns.

More particularly, aspects of the present disclosure are motivated by the observation that, while patterns of text input may vary widely across different applications for different users, a given user tends to employ similar (and sometimes identical) sentence and/or phrase constructions across different applications (e.g., instant messaging applications, text messaging applications, email applications, etc.). In view of such observation, aspects of the present disclosure provide the opportunity to optimize text-entry on a per-user basis. In particular, aspects of the present disclosure enable a user to create one or more custom, user-specific shorthand stroke patterns which map to longer, commonly used text strings.

In some implementations, aspects of the present disclosure can be implemented by or as a portion of a text entry application. For example, the text entry application can integrate or otherwise operate in conjunction with an operating system of a mobile computing device to provide different functionalities which enable a user to enter text into a text entry field of different applications (e.g., instant messaging applications, text messaging applications, email applications, etc.). For example, whenever a user requests to enter text into a particular application, the text entry application can be implemented to enable entry of such text.

More particularly, according to an aspect of the present disclosure, the text entry application can support or enable entry of text through handwriting. For example, the text entry application can provide a user interface that includes a handwriting entry window. The user can draw or otherwise enter a handwritten stroke pattern into the handwriting entry window of the user interface. For example, the user can use a finger, a stylus, or another object to interact with a touch-sensitive component of the mobile computing device (e.g., a touch-sensitive display screen) to enter the handwritten stroke pattern. However, as will be discussed further below, the present disclosure is not limited to user entry of the stroke pattern via a touch-sensitive component, but instead can be applied to any user-entered stroke pattern, regardless of the mechanism by which the stroke pattern was entered.

In some implementations, the handwriting entry window of the user interface does not display a keyboard. As such, the handwritten stroke pattern is not entered by the user upon a keyboard of the mobile computing device. Such is in contrast to various text entry applications which enable a user to enter text by sliding a finger or stylus upon an on-screen keyboard from the first letter of a word to its last letter, lifting between words. In other implementations, the handwriting entry window of the user interface does display a keyboard and the input stroke pattern is entered by the user upon the keyboard.

The text entry application can recognize the handwritten stroke pattern and enter corresponding text into a text entry field selected by the user (e.g., a text entry field of another application that is actively implemented on the device). In particular, according to aspects of the present disclosure, the handwritten stroke pattern can include not only handwritten text strings (e.g., a handwritten approximation of the phrase “hello world”) but also custom handwritten shorthand stroke patterns that can be used as shortcuts for entry of longer sentences or phrases respectively associated therewith.

More particularly, as noted above, an example mobile computing device of the present disclosure enables a user to input or otherwise define a plurality of shorthand stroke patterns which serve as shortcuts for entry of longer sentences or phrases defined by the user. In one example, a given shorthand stroke pattern can include one or more strokes that approximate a non-linguistic symbol (i.e., a symbol not contained in a language). For example, an example shorthand stroke pattern can be a hand-drawn picture of a train. As such, the shorthand stroke pattern does not include strokes which approximate a linguistic symbol such as the English letter “A”. To continue the example, such shorthand stroke pattern can correspond to an output text string of “I'm on the train.”

In another example, a given shorthand stroke pattern can include one or more strokes that approximate a linguistic symbol (i.e., a symbol contained in a language). For example, an example shorthand stroke pattern can be a handwritten text input that approximates the string “wmeet.” Such shorthand stroke pattern can correspond to an output text string of “Where are we meeting?”

As yet another example, a given shorthand stroke pattern can include one or more strokes that approximate a linguistic symbol and also one or more strokes that approximate a non-linguistic symbol. For example, an example shorthand stroke pattern can be a hand-drawn picture of a house (non-linguistic symbol) with a question mark linguistic symbol drawn inside. Such shorthand stroke pattern can be mapped to the output text string “When will you be home?”

In some implementations, the user interface of the text entry application can include a button or other feature which, when selected by the user, causes the text entry application to switch into a shortcut mode. When in shortcut mode, the mobile computing device can analyze received input for the presence of a previously defined shorthand stroke pattern. In addition, in such implementations, when placed into the shortcut mode, the user can select another button or icon to begin creation of a new shorthand stroke pattern.

In particular, if the mobile computing device receives a user request to create a new shorthand stroke pattern, the mobile computing device can prompt the user to write and/or draw one or more examples of the new shorthand stroke pattern that she would like to use as the shorthand cue. As discussed above, the design of new shorthand stroke pattern is entirely up to the user and can contain strokes that approximate linguistic symbols and/or strokes that approximate non-linguistic symbols (e.g., random stroke combinations or hand-drawn pictures).

The mobile computing device also asks the user to enter the corresponding text string to which she would like the new shorthand stroke pattern to expand. As one example, after entry of one or more examples of the shorthand stroke pattern, the user can be prompted to enter the corresponding text (e.g., using a virtual keyboard, using the handwriting entry window of the application, and/or using voice entry). As an alternative example, the corresponding text can be selected from a pre-populated list that is pre-filled with text snippets that are commonly used by the user (e.g., sorted by their frequency). As yet another example, if an existing (e.g., previously entered) text string was selected when the user request to create the new shorthand stroke pattern was received, then such existing text string can be used as the corresponding output text associated with the new shorthand stroke pattern.

According to another aspect of the present disclosure, the one or more examples of the new shorthand stroke pattern can be used to train a shorthand pattern recognizer included in the text entry application. Thereafter, when the user enters an input stroke pattern, the shorthand pattern recognizer can determine whether the input stroke pattern matches one of the plurality of shorthand stroke patterns previously defined by the user (including, for example, the new shorthand stroke pattern whose creation was described above).

More particularly, in some implementations, the text entry application can include an input recognizer that serves to recognize handwritten input entered by the user. In some implementations, the input recognizer can include both a handwritten text recognizer and a shorthand pattern recognizer. The handwritten text recognizer can be used to recognize handwritten text, such as, for example, a handwritten approximation of the phrase “hello world.” The shorthand pattern recognizer, however, can be used to match an input stroke pattern against the previously user-defined shorthand stroke patterns.

In some implementations, an input stroke pattern input by the user is provided to the shorthand pattern recognizer only when the user has placed the text entry application into the shortcut mode described above. In such implementations, in all other instances, the input stroke pattern is assumed to be handwritten text and is provided to the handwritten text recognizer for recognition. Thus, one benefit of an explicit user-toggleable shortcut mode is to enable the input recognizer to operate on a smaller space of stroke patterns that the user has designated as shorthand cues (e.g., by providing the input stroke pattern to the shorthand pattern recognizer only).

However, as will be discussed further below, in some implementations, the text entry application does not have and/or does not require use of an explicit shortcut mode. As one example, an input stroke pattern can be provided to both the handwritten text recognizer and the shorthand pattern recognizer and the text entry application can select one of outputs from such recognizers for use (e.g., on the basis of respective confidence scores provided by the recognizers). As another example, the input recognizer can include a preliminary classifier that preliminarily classifies the input stroke pattern as either a shorthand pattern or as handwritten text. Based on such preliminary classification, the input stroke pattern can then be provided to either the handwritten text recognizer or the shorthand pattern recognizer for more specific recognition, as the preliminary classification dictates. Similar to the shorthand pattern recognizer discussed above, when the user adds a new shorthand stroke pattern, the one or more examples of the new shorthand stroke pattern can be used to train or re-train the preliminary classifier as well.

According to another aspect of the present disclosure, the shorthand pattern recognizer can be various types or forms of classifiers and/or machine-learned models. As one example, the shorthand pattern recognizer can be a neural network (e.g., a deep neural network or other multi-layer non-linear model). As another example, the shorthand pattern recognizer can be a nearest neighbor classifier. One benefit of use of a nearest neighbor classifier is that it is easier to extend the classifier to support more classes (e.g., more shorthand stroke patterns) without an expensive re-training process which can be problematic on mobile devices.

According to another aspect of the present disclosure, in some implementations, the text entry application can serve as an assistant for the user. For example, the text entry application can analyze user inputted text (e.g., text inputted through a keyboard or via handwritten input) and can identify one or more commonly entered text strings. Thereafter, the text entry application can suggest that the user associate one of the one or more commonly entered text strings with a new shorthand stroke pattern. As one example, a small prompt can be shown to the user which reads, for example, “Do you want to setup a shorthand cue for entering these words faster?” and which allows the user to optionally start the shortcut creation process.

Thus, in some implementations, in order to obtain the benefits of the techniques described herein, the user may be required to allow the periodic collection and analysis of text entered into the device by the user into the mobile computing device. Therefore, in some implementations, users can be provided with an opportunity to adjust settings that control whether and how much the systems and methods of the present disclosure collect and/or analyze such information. However, if the user does not allow collection and use of such information, then the user may not receive the benefits of the techniques described herein. In addition, in some embodiments, certain information or data can be treated in one or more ways before or after it is used, so that personally identifiable information is removed or not stored permanently.

According to yet another aspect of the present disclosure, the user-defined shorthand stroke patterns and associated output text strings can be shared among multiple mobile devices owned by or otherwise associated with a single user. As one example, to share shorthand stroke patterns across a user's devices, one or more features can be extracted from each shorthand stroke pattern. The feature(s) extracted from each shorthand stroke pattern can be saved in association with the user's user account in a centralized server computing device. In particular, in some implementations, the feature(s) can be stored and shared rather than data that describes the actual stroke pattern itself. The centrally stored data can be periodically downloaded or otherwise updated so that it is available on all of the user's devices and/or can also be used in cloud-based text entry methods.

Thus, the systems and methods of the present disclosure enable users to define custom stroke patterns for phrases and/or sentences that the user frequently uses when entering text into a mobile device, across a range of applications. In particular, the systems and methods of the present disclosure use handwritten shorthand stroke patterns as a cue for a shortcut to entry of a corresponding output text string (e.g., a longer Unicode text string).

Furthermore, the systems and methods of the present disclosure have additional benefits which derive from the above discussed principles. For example, the systems and methods of the present disclosure also allow the user to define a new input language not supported by the text entry application or other similar text entry components. For example, the new user-defined input language can be a real language (e.g., Tibetan) or a fictional language (e.g., Tengwar, Klingon, etc.).

Another additional benefit achieved by the present disclosure is that the user can define their own custom way of writing the alphabets, improving the accuracy for their natural handwriting, and possibly also increasing their input speed. As an example, one possible use is to support Graffiti, which is a single-stroke handwriting system once used in certain personal digital assistant devices and thought to be less ambiguous to recognize.

With reference now to the Figures, example aspects of the present disclosure will now be discussed in further detail.

### Example Use of Shorthand Stroke Patterns

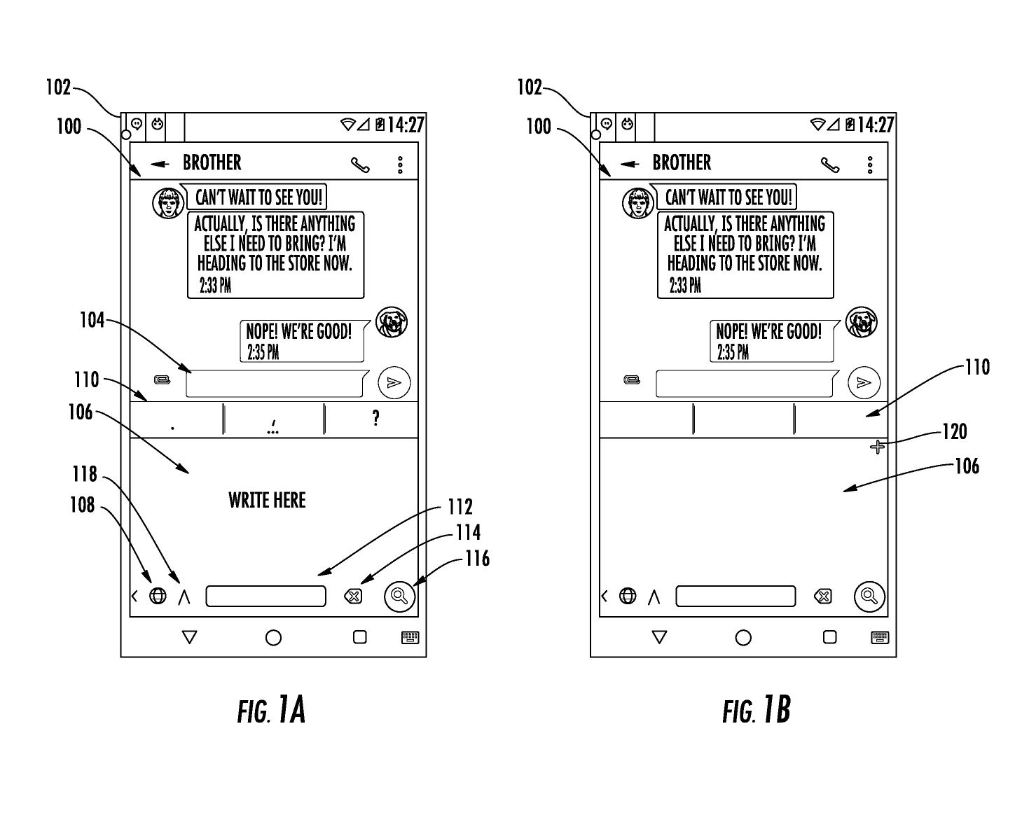

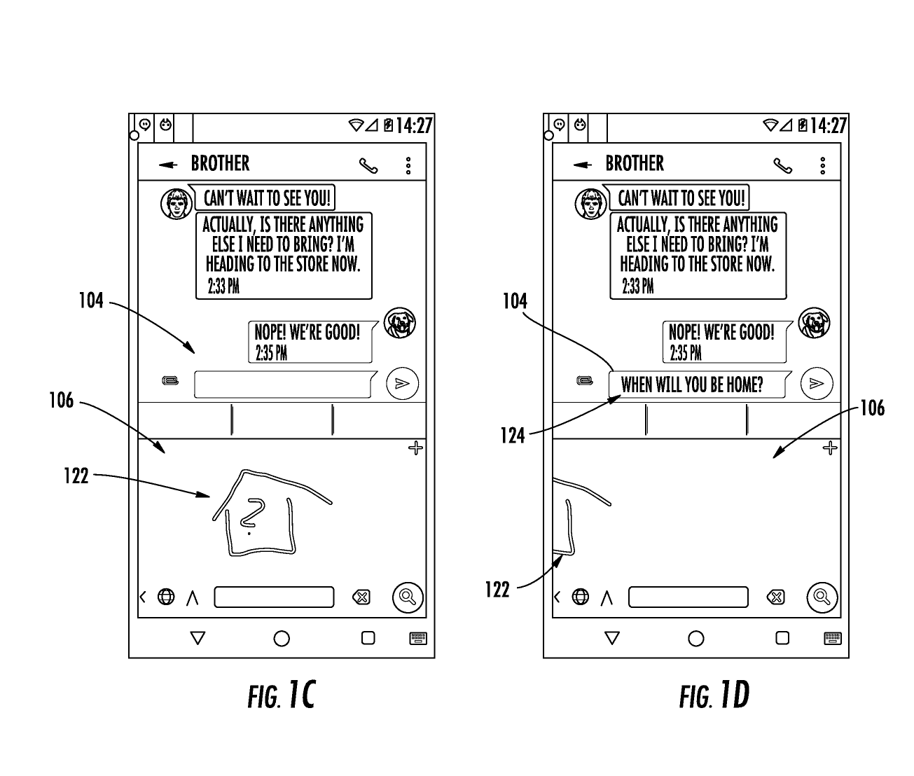

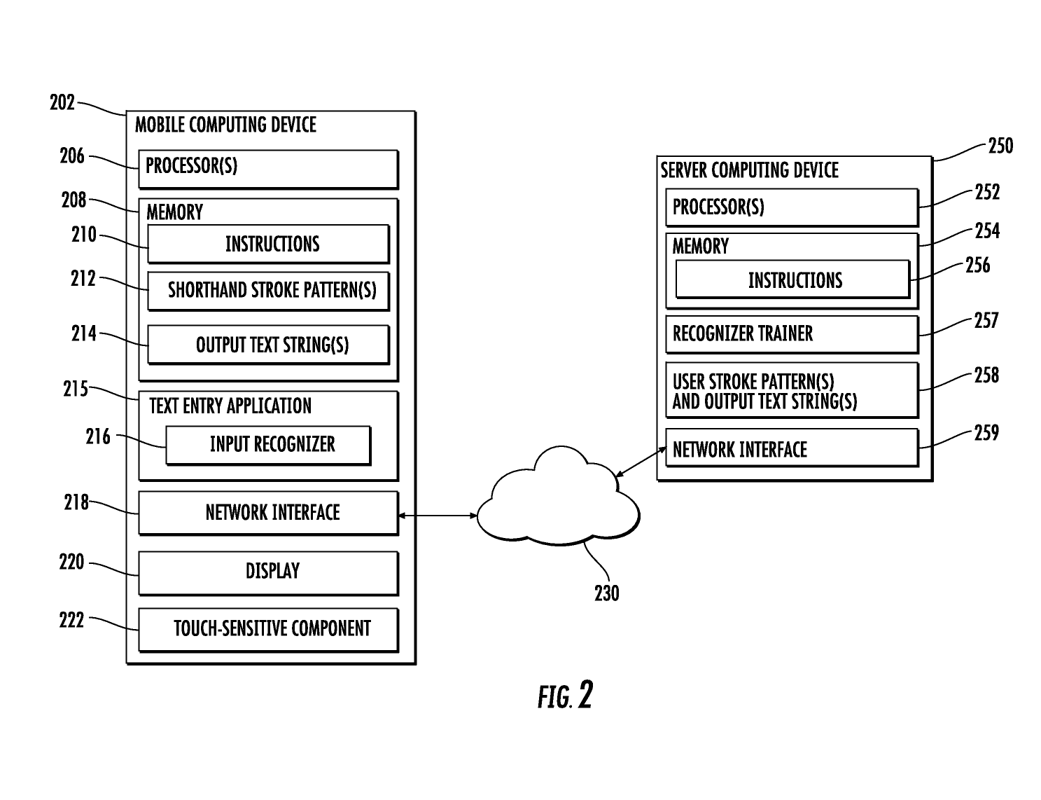

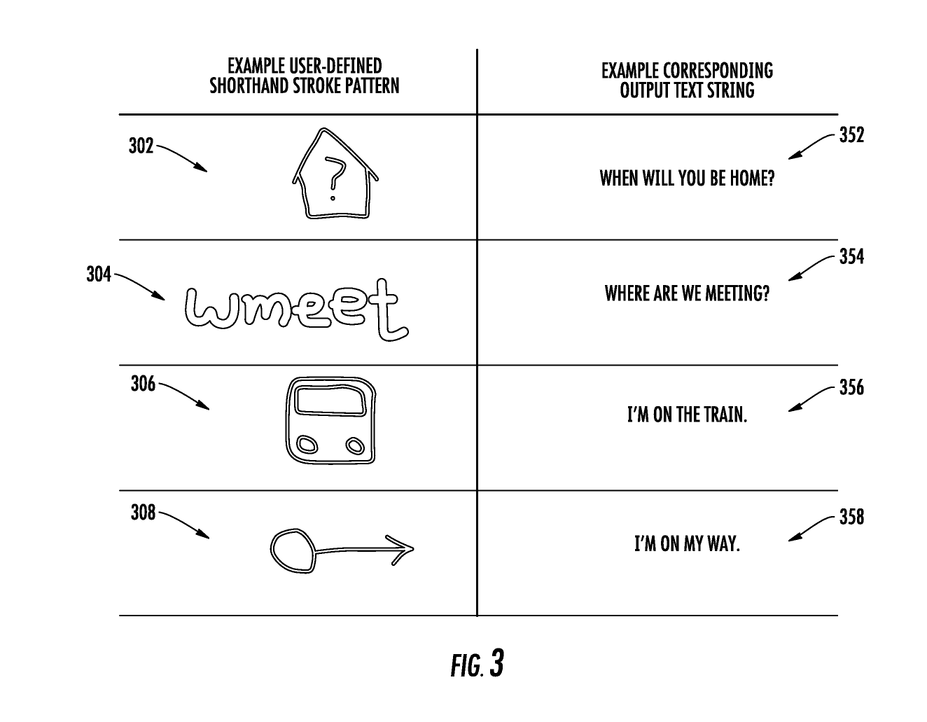

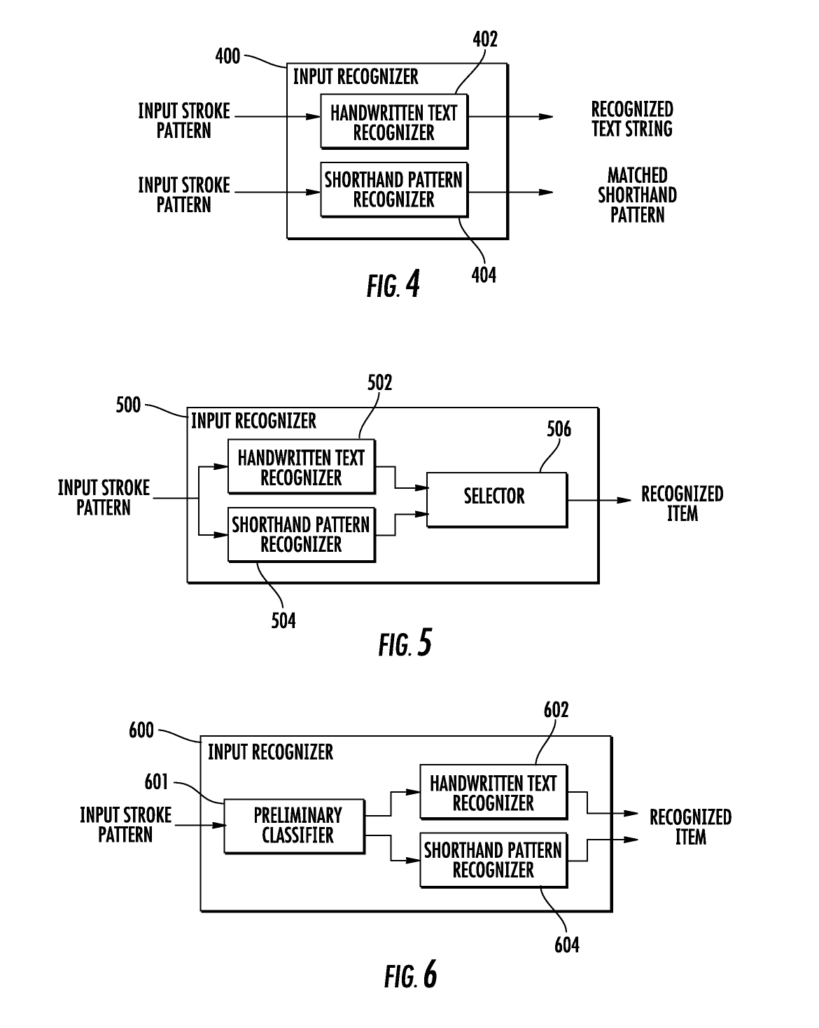

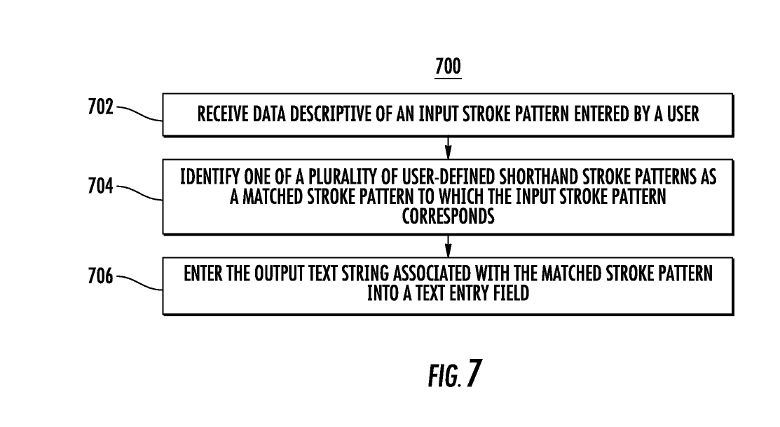

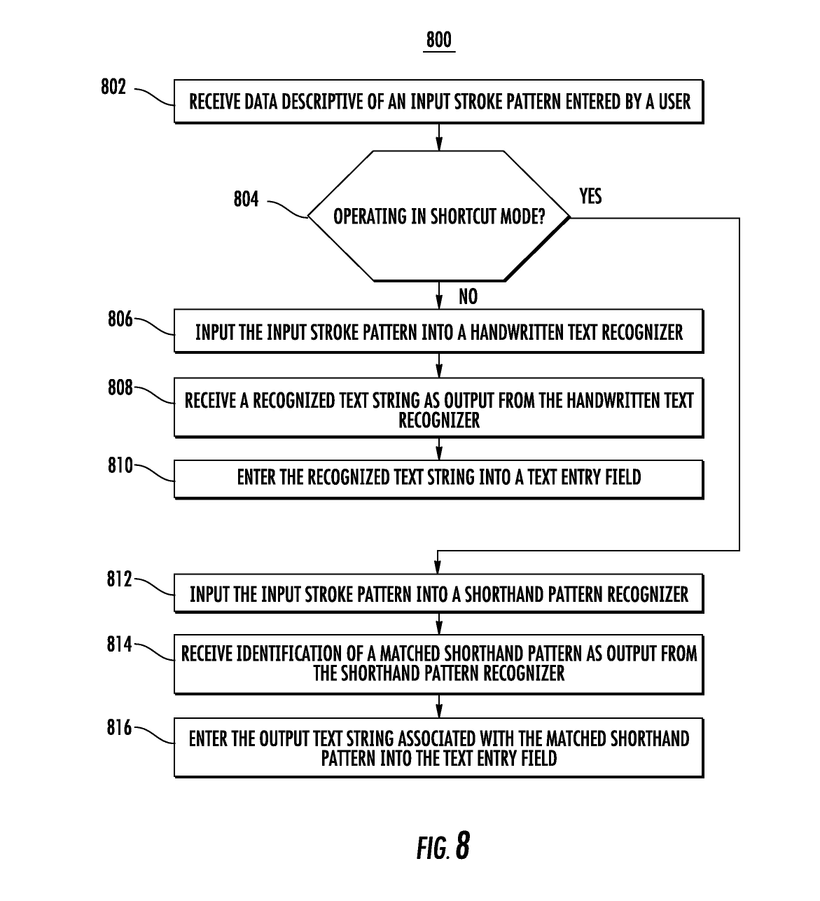

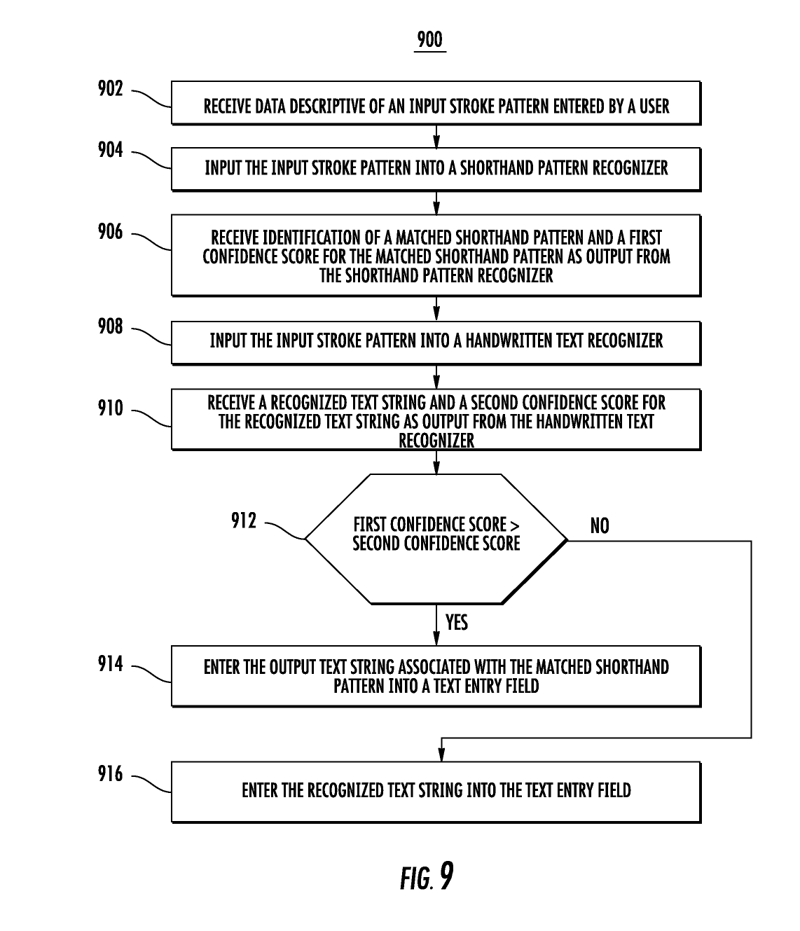

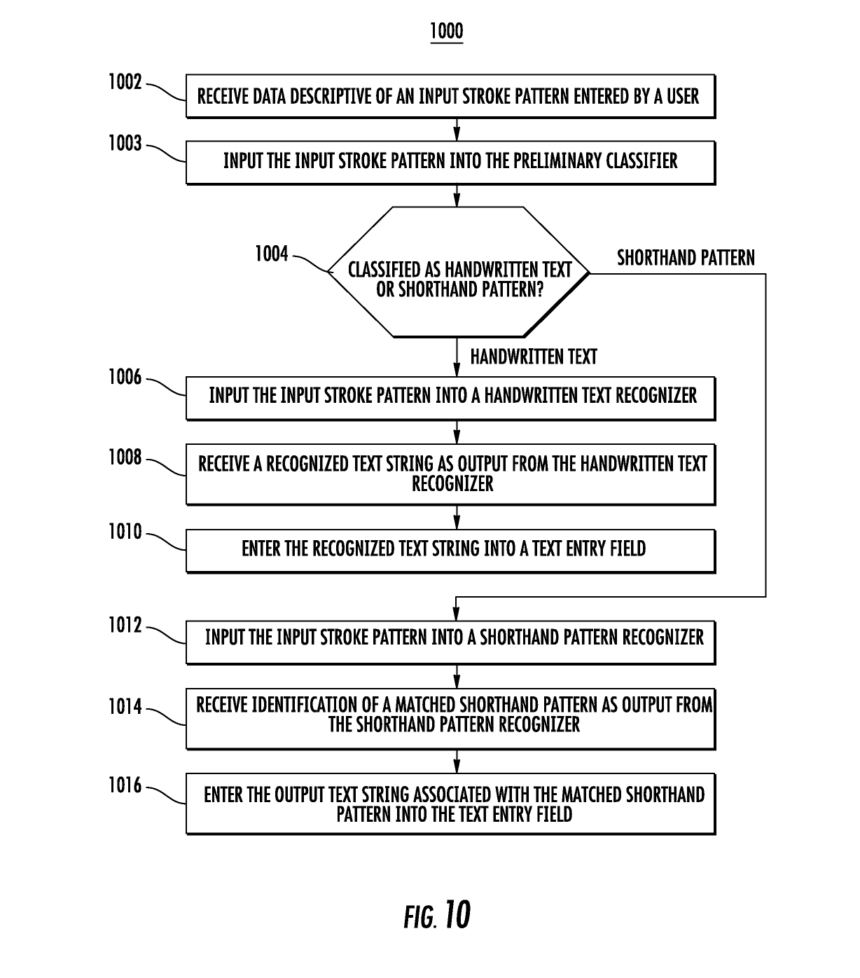

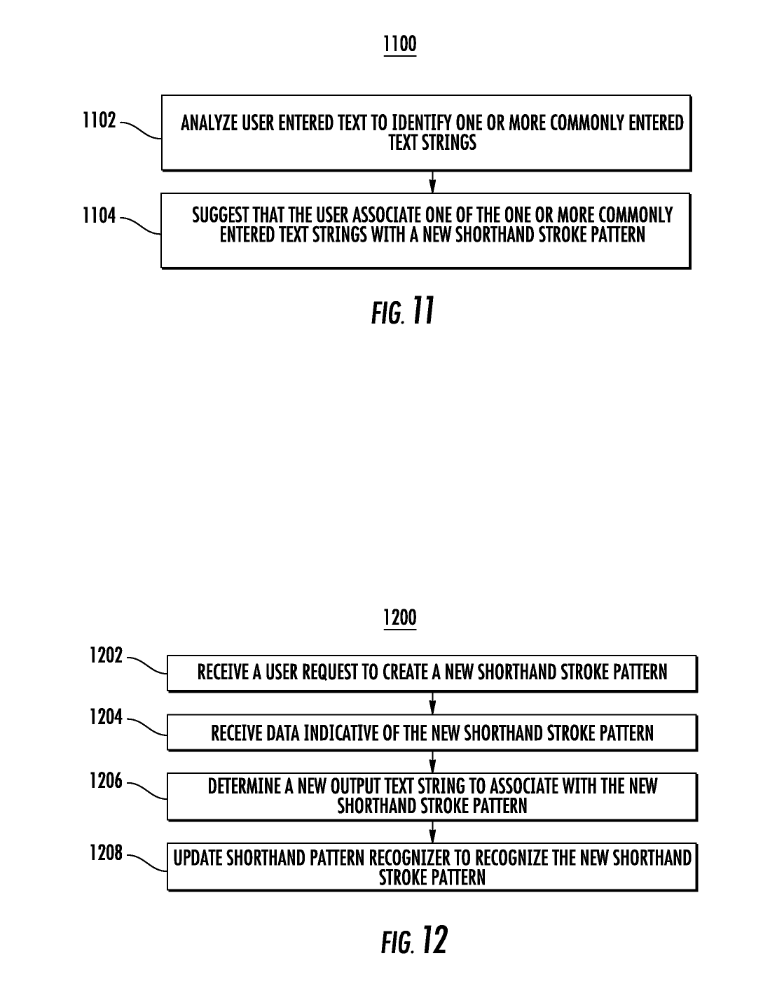

FIGS. 1A-D depict text entry into an example mobile computing device 102 through the use of a handwritten shorthand stroke pattern 122 according to example embodiments of the present disclosure. In particular, FIGS. 1A-D show sequential user interfaces of a text entry application and a text messaging application as a user enters into a shortcut mode, the user inputs the input stroke pattern 122, and the text entry application recognizes the input stroke pattern 122 and enters a corresponding output text string 124 into a text entry field 104.

Referring first to FIG. 1A, a display 100 of the mobile computing device 102 displays a user interface of the text messaging application in an upper portion and a user interface of the text entry application in a lower portion. More particularly, the text entry application illustrated in FIGS. 1A-1D enables the user to enter text into different applications executed by the mobile computing device 102. Thus, whenever a user requests to enter text into a particular application, the text entry application can be implemented to enable entry of such text. As a particular example, as illustrated in FIGS. 1A-D, the text entry application can enable a user to enter text into a text entry field 104 of the text messaging application.

According to an aspect of the present disclosure, the text entry application can support or enable entry of text through handwriting. In particular, the user interface of the text entry application can include a handwriting entry window 106. The user can draw or otherwise enter a handwritten stroke pattern into the handwriting entry window 106 of the user interface. For example, the user can use a finger, a stylus, or another object to interact with a touch-sensitive component of the mobile computing device 102 (e.g., a touch-sensitive display screen 100) to enter the handwritten stroke pattern. The text entry application can recognize the handwritten stroke pattern and enter corresponding text into the text entry field 104 of the text messaging application. In the particular example illustrated in FIGS. 1A-D, the user uses a shorthand stroke pattern to achieve entry of a longer text string into the text entry field 104.

Referring still to FIG. 1A, in some implementations, when the user interface of the text entry application is first displayed to the user (e.g., initially upon each use), the textual phrase “WRITE HERE” can be displayed within the handwriting entry window 106. Such may remind the user of the functionality and/or purpose of the handwriting entry window 106. Alternatively or additionally, a dashed horizontal line can be displayed (either initially or constantly) in the handwriting entry window 106. The horizontal line can serve as a baseline with respect to which the user can perform handwriting.

The user interface of the text entry application can further include a number of additional features, buttons, icons, or other objects. For example, a globe icon 108 can permit the user to switch between different text entry forms (e.g., handwriting versus on-screen keyboard) or between different text entry applications altogether (e.g., a basic operating system on-screen keyboard versus a special handwriting entry application versus a foreign language text entry application, etc.) Thus, the present disclosure is equally applicable to text entry applications which have a handwriting text entry method as the normal or basic text entry mode, text entry applications that have a more traditional on-screen keyboard as the basic text entry mode, or some combination thereof (e.g., a user can selectively switch between keyboard and handwritten text entry mode using, for example, the globe icon 108).

The user interface of the text entry application can also include a suggestion bar 110 that provides one or more (e.g., three) suggested completions of the current word being written and/or additions to the currently entered text. For example, when no text has been entered, the suggestion bar 110 can include a period, a comma, and a question mark, as illustrated in FIG. 1A.

As further examples, the user interface of the text entry application can also include a space bar 112, a delete button 114, a return button (not shown), and/or a search button 116. In some implementations, the user interface can further include an emoji button (not shown) that enables the user to quickly switch in and out of an emoji mode. As an example, when the text entry application is cooperating with certain applications which include a send button (e.g., a text messaging or chat application, etc.) the search button 116 can be replaced with the emoji button. In some implementations, the search button 116 is included in the user interface only when the text entry field into which text is entered corresponds to a search box which receives a search query. Further, in addition or alternatively to such buttons, the text entry application can recognize certain gestures or handwritten input as corresponding to or otherwise requesting the functionality of the space bar 112, delete button 114, etc.

In addition, according to an aspect of the present disclosure, the user interface of the text entry application can include a shortcut mode control button 118. The user can press the shortcut mode control button 118 to toggle the text entry application in and out of a shortcut mode. When in shortcut mode, the text entry application can analyze received input for the presence of a previously defined shorthand stroke pattern. However, as will be discussed further below, in some implementations, the text entry application does not have and/or does not require use of an explicit shortcut mode.

Referring now to FIG. 1B, the display 100 of FIG. 1B shows the user interface of the text entry application after the user has selected the shortcut mode control button 118 to place the text entry application in the shortcut mode. As illustrated in FIG. 1B, the handwriting entry window 106 is blank and ready for entry of a shorthand stroke pattern. Further, the suggestion bar 110 is also blank and does not provide any suggestions.

In addition, a shortcut creation button 120 is provided in the user interface. For example, the shortcut creation button 120 can take the form of a “plus sign” icon placed within the handwriting entry window 106, as illustrated in FIG. 1B. The user can select the shortcut creation button 120 to start a process to create a new shorthand stroke pattern. However, for the purpose of explaining FIGS. 1A-D, it will be assumed that the shorthand stroke pattern 122 entered by the user has already been created.

Referring now to FIG. 1C, it can be seen that the user has entered an input stroke pattern 122 into the handwriting entry window 106. For example, the user can have used her finger, a stylus, or another object to interact with the touch-sensitive display screen 100 to draw the strokes of the input stroke pattern 122. As illustrated, the input stroke pattern 122 is a stylized picture of a house with a question mark contained inside.

According to aspects of the present disclosure, during and/or after entry of the input stroke pattern 122, the text entry application can identify one of a plurality of previously user-defined shorthand stroke patterns as a matched shorthand pattern to which the input stroke pattern 122 corresponds. Example components and techniques for identifying the matched shorthand pattern will be discussed further below.

In response to identifying the matched shorthand pattern, the text entry application can enter an output text string associated with the matched shorthand pattern into a text entry field. In particular, as illustrated in FIG. 1D, the output text string 124 associated with the matched shorthand stroke pattern to which the input stroke pattern 122 corresponds has been entered into the text entry field 104 of the text messaging application.

Entering the output text string 124 into the text entry field 104 can include any actions, operations, or techniques which result in the output text string 124 being placed within the text entry field 104. For example, entering the output text string 124 into the text entry field 104 can include passing a text string from one application to another; providing data descriptive of the output text string 124 to the text entry application or an associated and/or cooperative application; or other data management techniques. Entering the output text string 124 into the text entry field 104 does not necessarily require use of an application programming interface.

In some implementations, in the presence of the suggestion/candidate bar 110, after the user draws the shorthand stroke pattern 122 in FIG. 1C, the candidate output text string 124 can be shown in the candidate bar 110. The user can then select the displayed text string 124 from the candidate bar 110 to confirm it and insert it into the text entry field 104 in FIG. 1D. Thus, in such implementations, the output text string 124 is suggested within the bar 110 rather than automatically entered into the text entry field 104.

In some implementations, after recognition of the input stroke pattern 122, the input stroke pattern 122 can be visually moved to the left, as is illustrated in FIG. 1D. Such may provide a visual indication to the user that the input stroke pattern 122 has been recognized and that the appropriate output text has been placed into the text entry field. However, in other implementations, the input stroke pattern 122 may simply be removed from the display 100 after recognition.

In such fashion, the user can obtain entry of the corresponding longer output text string 124 by entering an input stroke pattern 122 which matches or otherwise corresponds to a previously user-defined shorthand stroke pattern. Thus, aspects of the present disclosure provide faster text entry through the use and recognition of any number of user-defined shorthand stroke patterns.

Furthermore, in some implementations, as illustrated in FIGS. 1A-D, the handwriting entry window 106 of the user interface does not display a keyboard. As such, the input stroke pattern 122 is not entered by the user upon a keyboard of the mobile computing device. Such is in contrast to various text entry applications which enable a user to enter text by sliding a finger or stylus upon an on-screen keyboard from the first letter of a word to its last letter, lifting between words. In other implementations, the handwriting entry window 106 of the user interface does display a keyboard and the input stroke pattern 122 is entered by the user upon the keyboard.

The particular user interfaces and associated icons, buttons, and features depicted in FIGS. 1A-D are provided as examples only. The systems and methods of the present disclosure are not limited to the particular user interfaces illustrated in FIGS. 1A-D but, instead, can be implemented using many different user interfaces with various designs, appearances, features, etc.

As one example, in some implementations, a text entry application of the present disclosure may not require entry of the input stroke pattern 122 into the portion of the display 100 that shows the handwriting entry window 106 (and, in fact, may not display a discrete, defined handwriting entry window 106 at all). Instead, in such implementations, the user may be able to input the input stroke pattern 122 anywhere on the display 100 and it will be recognized as user input (e.g., the entire display 100 serves as the handwriting entry window 106).

### Example Systems

FIG. 2 depicts a block diagram an example computing system according to example embodiments of the present disclosure. The system includes a mobile computing device 202 that enables faster text entry through the use of handwritten shorthand stroke patterns defined by the user.

The mobile computing device 202 can be any form of mobile device, such as a smartphone, tablet, wearable computing device (e.g., computing device embedded in a pair of eyeglasses, a wristband, a necklace, etc.), handheld computing device, computing device embedded in a vehicle, etc. Further, although the systems and methods of the present disclosure are particularly beneficial when applied in the context of a mobile computing device, they are not limited to that scenario. Instead, the present disclosure can be implemented on any computing device, whether mobile or non-mobile.

The mobile computing device 202 includes one or more processors 206 and a memory 208. The one or more processors 206 can be any form of processing device, including, for example, a processing unit, a microprocessor, a controller, a microcontroller, an application specific integrated circuit, etc. The memory 208 can include one or more of any non-transitory computer-readable medium, including, for example, RAM (e.g., DRAM), ROM (e.g., EEPROM), optical storage, magnetic storage, flash storage, solid-state storage, hard drives, or some combination thereof. The memory 208 can store one or more sets of instructions 210 that, when executed by the mobile computing device 202, cause the mobile computing device 202 to perform operations consistent with the present disclosure.

The memory 208 can also store one or more shorthand stroke patterns 212 and one or more output text strings 214 respectively associated with the one or more shorthand stroke patterns 212. For example, the shorthand stroke patterns 212 and the output text strings 214 can be stored as data elements in a database or other data storage construct. Furthermore, in some implementations, in addition or alternatively to storing data that describes (e.g., permits replication of) each shorthand stroke pattern 212, the memory 208 can store one or more features extracted from each shorthand stroke pattern 212.

As examples, FIG. 3 depicts a graphical representation of a table that contains example user-defined shorthand stroke patterns 302-308 and corresponding output text strings 352-358 according to example embodiments of the present disclosure. In particular, each shorthand stroke pattern 302-308 is shown in the left-hand column while its respective corresponding output text string 352-358 is shown in the right-hand column of the table. As illustrated in FIG. 3, the example shorthand stroke patterns 302-308 can be defined by the user and can take various forms having various complexities.

In one example, a shorthand stroke pattern can include one or more strokes that approximate a non-linguistic symbol (i.e., a symbol that is not contained in a language). For example, the example shorthand stroke pattern 306 is a hand-drawn picture of a train. As such, the shorthand stroke pattern 306 does not include strokes which approximate a linguistic symbol such as the English letter “A”. The shorthand stroke pattern 306 corresponds to an output text string 356 of “I'm on the train.”

In another example, a shorthand stroke pattern can include one or more strokes that do approximate a linguistic symbol (i.e., a symbol contained in a language). For example, the example shorthand stroke pattern 304 is a handwritten text input that approximates the string “wmeet.” The shorthand stroke pattern 304 corresponds to an output text string 354 of “Where are we meeting?”

As yet another example, a shorthand stroke pattern can include one or more strokes that approximate a linguistic symbol and also one or more strokes that approximate a non-linguistic symbol. For example, the example shorthand stroke pattern 302 is a hand-drawn picture of a house (non-linguistic symbol) with a question mark linguistic symbol drawn inside. The shorthand stroke pattern 302 is mapped to the output text string 352 of “When will you be home?”

The particular shorthand stroke patterns 302-308 and corresponding output text strings 352-358 provided in FIG. 3 are provided as examples only. As noted above, according to aspects of the present disclosure, both the shorthand stroke patterns and the output text strings can be defined by the user and, therefore, can have various forms having various complexities.

Referring again to FIG. 2, the mobile computing device 202 can also include a text entry application 215. The text entry application 215 can include a set of instructions which, when executed by the one or more processors 206, cause the mobile computing device 202 to provide different functionalities which enable a user to enter text into a text entry field of different applications (e.g., instant messaging applications, text messaging applications, email applications, etc.). For example, whenever a user requests to enter text into a particular application, the mobile computing device 202 can implement the text entry application 215 to enable entry of such text. Thus, in some implementations text entry application 215 can be a stand-alone application which can interact or otherwise interoperate with a number of other separate applications. In other implementations, the text entry application 215 is a component of a single application that provides a primary functionality other than text entry.

Thus, the text entry application 215 includes computer logic utilized to provide desired functionality. The text entry application 215 can be implemented in hardware, firmware, and/or software controlling a general purpose processor. For example, in some implementations, the text entry application 215 includes program files stored on a storage device, loaded into a memory and executed by one or more processors. In other implementations, the text entry application 215 includes one or more sets of computer-executable instructions that are stored in a tangible computer-readable storage medium such as RAM, hard disk, or optical or magnetic media.

According to an aspect of the present disclosure, the text entry application 215 can support or enable entry of text through handwriting. For example, the text entry application 215 can provide a user interface that includes a handwriting entry window. The user can draw or otherwise enter a handwritten stroke pattern into the handwriting entry window of the user interface. For example, the user can use a finger, a stylus, or another object to interact with a touch-sensitive component 222 of the mobile computing device 202 (e.g., a touch-sensitive display screen 220) to enter the handwritten stroke pattern. However, as will be discussed further below, the present disclosure is not limited to user entry of the stroke pattern via a touch-sensitive component 222, but instead can be applied to any user-entered stroke pattern, regardless of the mechanism by which the stroke pattern was entered (e.g., stroke entry through computer vision, RADAR, a digitizer/graphic tablet, a mouse, or other technologies).

The text entry application 215 can recognize the handwritten stroke pattern and enter corresponding text into a text entry field selected by the user (e.g., a text entry field of another application that is actively implemented on the device). In particular, the text entry application 215 can include an input recognizer 216 that recognizes the handwritten stroke pattern. Further, according to aspects of the present disclosure, the input recognizer 216 can recognize not only handwritten text strings (e.g., a handwritten approximation of the phrase “hello world”) but also custom handwritten shorthand stroke patterns that can be used as shortcuts for entry of longer sentences or phrases respectively associated therewith.

In some implementations, the input recognizer 216 includes one or more classifiers, neural networks, or machine-learned models which assist in classifying or otherwise recognizing received input. Example structures and modes of operation of the input recognizer 216 will be discussed further below with reference to FIGS. 4-6 and elsewhere. Thus, in some implementations, the input recognizer 216 can be implemented in hardware, firmware, and/or software controlling a general purpose processor.

In some implementations, the input recognizer 216 includes both a handwritten text recognizer and a shorthand pattern recognizer. The handwritten text recognizer can recognize handwritten text, such as, for example, a handwritten approximation of the phrase “hello world.” In particular, the handwritten text recognizer can receive a stroke pattern as an input and, in response, output a recognized text string which the input stroke pattern is believed to approximate. In some implementations, the handwritten text recognizer can output a confidence score descriptive of a confidence that the input stroke pattern corresponds to the recognized text string.

The shorthand pattern recognizer can match, classify, or otherwise compare an input stroke pattern against the previously user-defined shorthand stroke. The shorthand pattern recognizer can be various types or forms of classifiers and/or machine-learned models.

As one example, the shorthand pattern recognizer can be a neural network (e.g., a deep neural network or other multi-layer non-linear model). In some implementations, the neural network can receive an input stroke pattern as an input and, in response, output a plurality of confidence scores respectively for the plurality of user-defined shorthand stroke patterns. The confidence score for each shorthand stroke pattern can describe a confidence that the input stroke pattern corresponds to such shorthand stroke pattern. The shorthand stroke pattern that received the largest confidence score can then be selected or otherwise treated as the matched shorthand pattern. In other implementations, the neural network can output only a single confidence score for a particular shorthand stroke pattern that has been identified as the matched shorthand pattern. In yet other implementations, two or more output text strings (e.g., three) that correspond to two or more of the shorthand stroke patterns that received the largest confidence scores can be placed within a suggestions/candidate bar and the user can select one of the displayed output text strings for entry into the text entry field.

As another example, the shorthand pattern recognizer can be a nearest neighbor classifier. One benefit of use of a nearest neighbor classifier is that it is easier to extend the classifier to support more classes (e.g., more shorthand stroke patterns) without an expensive re-training process which can be problematic on mobile devices. In some implementations, the nearest neighbor classifier can receive an input stroke pattern as an input and, in response, output a classification of the input stroke pattern into one of a plurality of classes respectively associated with the plurality of shorthand stroke patterns. In some implementations, the nearest neighbor classifier can also output a confidence score descriptive of a confidence in the classification of the input stroke pattern. As described above, in some implementations, two or more output text strings (e.g., three) that correspond to two or more of the shorthand stroke patterns that received the largest confidence scores can be placed within a suggestions/candidate bar and the user can select one of the displayed output text strings for entry into the text entry field.

As one example structure of an input recognizer, FIG. 4 depicts a block diagram of an example input recognizer 400 according to example embodiments of the present disclosure. The input recognizer 400 includes a handwritten text recognizer 402 and a shorthand pattern recognizer 404. The input recognizer 400 can be used in implementations of the present disclosure in which the text entry application operates in an explicit shortcut mode.

In particular, for the input recognizer 400 illustrated in FIG. 4, an input stroke pattern entered by the user is provided to the shorthand pattern recognizer 404 only when the user has placed the text entry application into the shortcut mode. In such instances, the shorthand pattern recognizer 404 can output an identification of the matched shorthand pattern. Thereafter, the output text string associated with the matched shorthand pattern can be placed into a text entry field.

However, for the input recognizer 400 illustrated in FIG. 4, when the text entry application has not been placed into the shortcut mode, the input stroke pattern is assumed to be handwritten text and is provided to the handwritten text recognizer 402 for recognition. The handwritten text recognizer 402 can output a recognized text string which can thereafter be entered into the text entry field. Thus, one benefit of an explicit user-toggleable shortcut mode is to enable the shorthand pattern recognizer 404 to operate on a smaller space of stroke patterns that the user has designated as shorthand cues.

In further implementations, the recognized text string output by the handwritten text recognizer 402 can be analyzed to determine whether the recognized text string should be treated as a shorthand stroke pattern. More particularly, shorthand stroke patterns which include one or more strokes that approximate linguistic symbols (e.g., “wmeet”) can be recognized better by the handwritten text recognizer 402 versus the shorthand pattern recognizer 404. For example, use of the handwritten text recognizer 402 can allow the user to obtain recognition of the “wmeet” shorthand stroke pattern written in either printed or cursive variations. Thus, in some implementations, the recognized text string output by the handwritten text recognizer 402 can be subject to an additional analysis to determine whether the recognized text string should be treated as a shorthand stroke pattern.

In some implementations, the text entry application does not have and/or does not require use of an explicit shortcut mode. As one example, FIG. 5 depicts a block diagram of an example input recognizer 500 according to example embodiments of the present disclosure. The input recognizer 500 includes a handwritten text recognizer 502, a shorthand pattern recognizer 504, and a selector 506.

For the input recognizer 500 illustrated in FIG. 5, each input stroke pattern entered by a user can be provided to both the handwritten text recognizer 502 and the shorthand pattern recognizer 504. The shorthand pattern recognizer 504 can output a matched shorthand pattern and a first confidence score. The handwritten text recognizer 502 can output a recognized text string and a second confidence score.

The selector 506 can select one of outputs from such recognizers for use. For example, the selector 506 can select the output with the larger confidence score provided by its respective recognizer. The selected output can be used for entering text into the text field. In some implementations, if the confidence scores are relatively similar in magnitude (e.g., a difference between the scores does not exceed a threshold value), then the text entry application can request that the user select either the output text associated with the matched shorthand pattern or the recognized text string for entry into the text entry field. For example, the output text associated with the matched shorthand pattern and the recognized text string for entry into the text entry field can each be placed within a suggestions/candidate bar of the user interface and the user can select one of the displayed strings for entry.

In further implementations, the selector 506 can analyze the recognized text string output by the handwritten text recognizer 502 to determine whether the recognized text string should be treated as a shorthand stroke pattern.

As another example, FIG. 6 depicts a block diagram of an example input recognizer 600 according to example embodiments of the present disclosure. The input recognizer 600 includes a preliminary classifier 601, a handwritten text recognizer 602 and a shorthand pattern recognizer 604.

The preliminary classifier 601 can preliminarily classify the input stroke pattern into a first class associated with the plurality of shorthand stroke patterns or into a second class associated with handwritten text. Based on such preliminary classification, the input stroke pattern can then be provided to either the handwritten text recognizer 602 or the shorthand pattern recognizer 604, as the classification dictates. The output of whichever recognizer 602 or 604 is employed can be used for entry of text into the text entry field.

As examples, the preliminary classifier 601 can be various types of classifiers (e.g., nearest neighbor classifier), neural networks (e.g., deep neural network), or other pattern recognition components.

Referring again to FIG. 2, the mobile computing device 202 can further include a network interface 218, a display 220, and a touch-sensitive component 222. The network interface 218 can enable communications over a network 230. The network interface 218 can include any number of components to provide networked communications (e.g., transceivers, antennas, controllers, cards, etc.).

The display 220 can include different types of display components, such as, for example, a light-emitting diode display (e.g., organic light-emitting diode display), a liquid-crystal display (e.g., thin-film-transistor liquid-crystal display), a thin-film diode display, etc. In some implementations, the display 220 can also be touch-sensitive, thus also serving as the touch-sensitive component 222. For example, the display can be a capacitive touchscreen, a resistive touchscreen, or other touch-sensitive technologies.

The touch-sensitive component 222 can be any component able to record an input stroke pattern entered by the user. For example, the touch-sensitive component 222 can be a touch-sensitive display 220, as discussed above. As another example, the touch-sensitive component 222 can be a touchpad.

Furthermore, as discussed above, although the present disclosure is discussed with respect to a touch-sensitive component 222 for the purpose of explanation, the present disclosure is not limited to entry of stroke patterns via touch. Instead, the systems and methods of the present disclosure can be applied to any technologies which can capture entry of an input stroke pattern by a user (e.g., stroke entry through computer vision, RADAR, a digitizer/graphic tablet, a mouse, or other technologies).

In some implementations, the mobile computing device 202 can communicatively connect to a server computing device 250 over the network 230. The server computing device 250 can include one or more processors 252 and a memory 254. The one or more processors 252 can be any form of processing device, including, for example, a processing unit, a microprocessor, a controller, a microcontroller, an application specific integrated circuit, etc. The memory 254 can include one or more of any non-transitory computer-readable medium, including, for example, RAM (e.g., DRAM), ROM (e.g., EEPROM), optical storage, magnetic storage, flash storage, solid-state storage, hard drives, or some combination thereof. The memory 254 can store one or more sets of instructions 256 that, when executed by the server computing device 250, cause the server computing device 250 to perform operations consistent with the present disclosure.

In some implementations, the server computing device 250 can assist in storage, sharing, or other management of the shorthand stroke patterns and associated text strings created by the user. For example, user-defined shorthand stroke patterns and associated output text strings (shown collectively at 258) can be stored at the server computing device 250 and shared among multiple mobile devices owned by or otherwise associated with a single user.

As one example, to share shorthand stroke patterns across a user's devices, one or more features can be extracted from each shorthand stroke pattern. The feature(s) extracted from each shorthand stroke pattern can be saved in association with the user's user account in the centralized server computing device 250. In particular, in some implementations, the feature(s) can be stored and shared rather than data that describes (e.g., enables exact replication of) the actual stroke pattern itself. The centrally stored data 258 can be periodically downloaded or otherwise updated so that it is available on all of the user's devices and/or can also be used in cloud-based text entry methods.

In addition, in some implementations, server computing device 250 can also include a recognizer trainer 257. Server computing device 250 can implement the recognizer trainer 257 to train and/or re-train one or more recognizers such as the shorthand pattern recognizer of the input recognizer 216, which may be, for example, a classifier (e.g., nearest neighbor classifier), a neural network (e.g., deep neural network), or other pattern recognition components. As examples, the recognizer trainer 257 can perform back propagation techniques such as batch gradient descent or stochastic gradient descent to train the recognizer. The recognizer trainer 257 can also leverage dropout techniques to combat model overfitting. Thus, in some implementations, the server computing device 250 can implement the recognizer trainer 257 to train and/or update a shorthand pattern recognizer to recognize newly created shorthand stroke patterns. The updated recognizer can be downloaded by or pushed to each mobile computing device 202 associated with the user. Furthermore, in implementations which include a preliminary classifier within the input recognizer 216, the recognizer trainer 257 can be implemented to train and/or update the preliminary classifier when the user adds a new shorthand stroke pattern.

The server computing device 250 can further include a network interface 259. The network interface 259 can enable communications over the network 230. The network interface 259 can include any number of components to provide networked communications (e.g., transceivers, antennas, controllers, cards, etc.).

The network 230 can be any type of communications network, such as a local area network (e.g., intranet), wide area network (e.g., Internet), or some combination thereof and can include any number of wired or wireless links. In general, communication between the server computing device 250 and the mobile computing device 202 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). Server computing device 250 can communicate with the mobile computing device 202 over network 230 by sending and receiving data.

Further, any of the processes, operations, programs, applications, or instructions described as being stored at or performed by the server computing device 250 can instead be stored at or performed by the mobile computing device 202 in whole or in part, and vice versa. For example, in some implementations, the mobile computing device 202 can include and implement the recognizer trainer 257 locally.

As another example, in some embodiments, the input recognizer 216 can be located at the server computing device 250. In particular, the mobile computing device 202 can receive the input stroke pattern and upload data that describes the input stroke pattern to the server computing device 250. The server computing device 250 can include and implement the input recognizer 216 to recognize one or more shorthand stroke patterns. In some implementations, the server computing device 250 can communicate with the mobile computing device 202 to provide identification of the recognized shorthand stroke pattern. Alternatively or in addition, the server computing device 250 can communicate with the mobile computing device 202 to provide one or more corresponding output text strings. Thus, in some implementations, the patterns 212 and output text strings 214 can be stored in the memory 254 of the server computing device 250.

### Example Methods

FIG. 7 depicts a flow chart diagram of an example method 700 for text entry through shorthand stroke patterns according to example embodiments of the present disclosure.

At 702, the mobile computing device receives data descriptive of an input stroke pattern entered by a user. For example, a text entry application of the mobile computing device can receive data from a touch-sensitive component that describes the input stroke pattern entered by the user.

At 704, the mobile computing device identifies one of a plurality of shorthand stroke patterns as a matched stroke pattern to which the input stroke pattern corresponds. For example, an input recognizer of the text entry application can identify the matched stroke pattern to which the input stroke pattern corresponds. The shorthand stroke patterns may have been previously defined by a user.

As one example, to identify the matched shorthand pattern at 704, the mobile computing device can input the input stroke pattern into a shorthand pattern classifier. The mobile computing device can receive, as an output of the shorthand pattern classifier, a classification of the input stroke pattern into one of a plurality of classes respectively associated with the plurality of shorthand stroke patterns. For example, the shorthand pattern classifier can be a nearest neighbor classifier.

As another example, to identify the matched shorthand pattern at 704, the mobile computing device can input the input stroke pattern into a neural network and receive, as an output of the neural network, a plurality of confidence scores respectively for the plurality of shorthand stroke patterns. The confidence score for each shorthand stroke pattern describes a confidence that the input stroke pattern corresponds to such shorthand stroke pattern. The mobile computing device can select the shorthand stroke pattern with the largest confidence score as the matched shorthand pattern.

At 706, the mobile computing device enters an output text string associated with the matched stroke pattern into a text entry field. In particular, a plurality of output text strings can be respectively associated with the plurality of shorthand stroke patterns. The output text string associated with the matched stroke pattern can be identified and then entered into a text entry field.

Entering the output text string into the text entry field at 706 can include any actions, operations, or techniques which result in the output text string being placed within the text entry field. For example, entering the output text string into the text entry field at 706 can include passing a text string from one application to another; providing data descriptive of the output text string to the text entry application or an associated and/or cooperative application; or other data management techniques. Entering the output text string into the text entry field at 706 does not necessarily require use of an application programming interface (API), although in some implementations an API can be used.

FIG. 8 depicts a flow chart diagram of an example method 800 for text entry through shorthand stroke patterns according to example embodiments of the present disclosure.

At 802, a mobile computing device receives data descriptive of an input stroke pattern entered by a user. For example, a text entry application of the mobile computing device can receive data from a touch-sensitive component that describes the input stroke pattern entered by the user.

At 804, the mobile computing device can determine whether it is operating in a shortcut mode. For example, the text entry application can be user-toggleable in and out of an explicit shortcut mode. If it is determined at 804 that the mobile computing device is not operating in a shortcut mode, then method 800 can proceed to 806.

At 806, the mobile computing device inputs the input stroke pattern into a handwritten text recognizer. At 808, the mobile computing device receives a recognized text string as output from the handwritten text recognizer. At 810, the mobile computing device enters the recognized text string into a text entry field.

However, referring again to 804, if it is determined at 804 that the mobile computing device is operating in the shortcut mode, then method 800 proceeds to 812.

At 812, the mobile computing device inputs the input stroke pattern into a shorthand pattern recognizer. At 814, the mobile computing device receives identification of a matched shorthand pattern as output from the shorthand pattern recognizer. At 816, the mobile computing device enters an output text string associated with the matched shorthand pattern into the text entry field.

FIG. 9 depicts a flow chart diagram of an example method 900 for text entry through shorthand stroke patterns according to example embodiments of the present disclosure.

At 902, a mobile computing device receives data descriptive of an input stroke pattern entered by a user. For example, a text entry application of the mobile computing device can receive data from a touch-sensitive component that describes the input stroke pattern entered by the user.

At 904, the mobile computing device inputs the input stroke pattern into a shorthand pattern recognizer. At 906, the mobile computing device receives identification of a matched shorthand pattern and a first confidence score for the matched shorthand pattern as output from the shorthand pattern recognizer.

At 908, the mobile computing device inputs the input stroke pattern into a handwritten text recognizer. At 910, the mobile computing device receives a recognized text string and a second confidence score for the recognized text string as output from the handwritten text recognizer.

At 912, the mobile computing device determines whether the first confidence score is greater than the second confidence score. If it is determined at 912 that the first confidence score is greater than the second confidence score, then method 900 proceeds to 914. At 914, the mobile computing device enters the output text string associated with the matched shorthand pattern into the text entry field.

However, referring again to 912, if it is determined at 912 that the first confidence score is not greater than the second confidence score, then method 900 proceeds to 916. At 916, the mobile computing device enters the recognized text string into the text entry field.

In some implementations, if the first and second confidence scores are relatively similar in magnitude (e.g., a difference between the scores does not exceed a threshold value), then the text entry application can request that the user select either the output text associated with the matched shorthand pattern or the recognized text string for entry into the text entry field.

FIG. 10 depicts a flow chart diagram of an example method 1000 for text entry through shorthand stroke patterns according to example embodiments of the present disclosure.

At 1002, a mobile computing device receives data descriptive of an input stroke pattern entered by a user. For example, a text entry application of the mobile computing device can receive data from a touch-sensitive component that describes the input stroke pattern entered by the user.

At 1003, the mobile computing device inputs the input stroke pattern into a preliminary classifier. The preliminary classifier can preliminarily classify the input stroke pattern into a first class associated with the plurality of shorthand stroke patterns or into a second class associated with handwritten text.

At 1004, the mobile computing device determines whether the input stroke pattern was classified by the preliminary classifier as handwritten text or as a shorthand stroke pattern. If it is determined at 1004 that the input stroke pattern was classified as handwritten text, then method 1000 proceeds to 1006.

At 1006, the mobile computing device inputs the input stroke pattern into a handwritten text recognizer. At 1008, the mobile computing device receives a recognized text string as output from the handwritten text recognizer. At 1010, the mobile computing device enters the recognized text string into a text entry field.

However, referring again to 1004, if it is determined at 1004 that the input stroke pattern was classified as a shorthand pattern by the preliminary classifier, then method 1000 proceeds to 1012.

At 1012, the mobile computing device inputs the input stroke pattern into a shorthand pattern recognizer. At 1014, the mobile computing device receives identification of a matched shorthand pattern as output from the shorthand pattern recognizer. At 1016, the mobile computing device enters the output text string associated with the matched shorthand pattern into the text entry field.

According to another aspect of the present disclosure, in some implementations, the text entry application can serve as an assistant for the user. As one example, FIG. 11 depicts a flow chart diagram of an example method 1100 for suggestion of shorthand stroke pattern creation according to example embodiments of the present disclosure.

At 1102, a mobile computing device analyzes user entered text to identify one or more commonly entered text strings. For example, a text entry application of the mobile computing device can periodically collect and analyze user inputted text (e.g., text inputted through a keyboard or via handwritten input) and can identify one or more commonly entered text strings.

Thus, in some implementations, in order to obtain the benefits of the techniques described herein, the user may be required to allow the periodic collection and analysis of text entered into the device by the user into the mobile computing device. Therefore, in some implementations, users can be provided with an opportunity to adjust settings that control whether and how much the systems and methods of the present disclosure collect and/or analyze such information. However, if the user does not allow collection and use of such information, then the user may not receive the benefits of the techniques described herein. In addition, in some embodiments, certain information or data can be treated in one or more ways before or after it is used, so that personally identifiable information is removed or not stored permanently.

At 1104, the mobile computing device suggests that the user associate one of the one or more commonly entered text strings with a new shorthand stroke pattern. In particular, the text entry application can suggest that the user associate one of the one or more commonly entered text strings with a new shorthand stroke pattern. As one example, a small prompt can be shown to the user which reads, for example, “Do you want to setup a shorthand cue for entering these words faster?” and which allows the user to optionally start the shortcut creation process.

FIG. 12 depicts a flow chart diagram of an example method 1200 for creation of a new shorthand stroke pattern according to example embodiments of the present disclosure.

At 1202, the mobile computing device receives a user request to create a new shorthand stroke pattern. For example, the user may select a shortcut creation button in a user interface of a text entry application.

At 1204, the mobile computing device receives data indicative of the new shorthand stroke pattern. In particular, if the mobile computing device receives a user request to create a new shorthand stroke pattern, the mobile computing device can prompt the user to write and/or draw one or more examples of the new shorthand stroke pattern that she would like to use as the shorthand cue. As discussed above, the design of new shorthand stroke pattern is entirely up to the user and can contain strokes that approximate linguistic symbols and/or strokes that approximate non-linguistic symbols (e.g., random stroke combinations or hand-drawn pictures).

At 1206, the mobile computing device determines a new output text string to associate with the new shorthand stroke pattern. As one example, after entry of one or more examples of the shorthand stroke pattern, the user can be prompted to enter the corresponding text (e.g., using a virtual keyboard, using the handwriting entry window of the application, and/or using voice entry). As an alternative example, the corresponding text can be selected from a pre-populated list that is pre-filled with text snippets that are commonly used by the user (e.g., sorted by their frequency). As yet another example, if an existing (e.g., previously entered) text string was selected when the user request to create the new shorthand stroke pattern was received, then such existing text string can be used as the corresponding output text associated with the new shorthand stroke pattern.

At 1208, the mobile computing device updates a shorthand pattern recognizer to recognize the new shorthand stroke pattern. For example, the mobile computing device can leverage a recognizer trainer to update or re-train the shorthand pattern recognizer to recognize the new shorthand stroke pattern. The recognizer trainer can be located on the mobile computing device or at a server computing device.

### ADDITIONAL DISCLOSURE

The technology discussed herein makes reference to servers, databases, software applications, and other computer-based systems, as well as actions taken by and information sent to and from such systems. The inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to various specific example embodiments thereof, each example embodiment is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations, and/or additions to the present subject matter as would be readily apparent to one of ordinary skill in the art. For instance, features illustrated or described as part of one embodiment or implementation can be used with another embodiment or implementation to yield a still further embodiment. Thus, the present disclosure includes such alterations, variations, and equivalents.

In addition, although FIGS. 7-12 depicts steps performed in a particular order for purposes of illustration and discussion, the methods of the present disclosure are not limited to the particularly illustrated order or arrangement. The various steps illustrated in FIGS. 7-12 can respectively be omitted, rearranged, combined, and/or adapted in various ways without deviating from the scope of the present disclosure.

What is claimed is:

1. A computer-implemented method for text entry through handwritten shorthand stroke patterns, the method comprising:
receiving, by a mobile computing device, data descriptive of an input stroke pattern entered by a user, the input stroke pattern comprising one or more strokes that approximate a non-linguistic symbol;
identifying, by the mobile computing devices, one of a plurality of shorthand stroke patterns as a matched shorthand pattern to which the input stroke pattern corresponds, the plurality of shorthand stroke patterns previously defined by the user, a plurality of output text strings respectively associated with the plurality of shorthand stroke patterns; and
in response to identifying the matched shorthand pattern, entering, by the mobile computing device, the output text string associated with the matched shorthand pattern into a text entry field of the mobile computing device.

2. The computer-implemented method of claim 1, wherein identifying, by the mobile computing devices, one of the plurality of shorthand stroke patterns as the matched shorthand pattern comprises:
inputting, by the mobile computing device, the input stroke pattern into a shorthand pattern classifier; and
receiving, by the mobile computing device as an output of the shorthand pattern classifier, a classification of the input stroke pattern into one of a plurality of classes respectively associated with the plurality of shorthand stroke patterns.

3. The computer-implemented method of claim 2, wherein:
inputting, by the mobile computing device, the input stroke pattern into the shorthand pattern classifier comprises inputting, by the mobile computing device, the input stroke pattern into a nearest neighbor classifier; and
receiving, by the mobile computing device as the output of the shorthand pattern classifier, the classification comprises receiving, by the mobile computing device as an output of the nearest neighbor classifier, the classification of the input stroke pattern into one of the plurality of classes respectively associated with the plurality of shorthand stroke patterns.

4. The computer-implemented method of claim 2, wherein:
inputting, by the mobile computing device, the input stroke pattern into the shorthand pattern classifier comprises inputting, by the mobile computing device, the input stroke pattern into a neural network;
receiving, by the mobile computing device as the output of the shorthand pattern classifier, the classification comprises receiving, by the mobile computing device as an output of the neural network, a plurality of confidence scores respectively for the plurality of shorthand stroke patterns, wherein the confidence score for each shorthand stroke pattern describes a confidence that the input stroke pattern corresponds to such shorthand stroke pattern; and
the method further comprises selecting, by the mobile computing device, the shorthand stroke pattern with the largest confidence score as the matched shorthand pattern.

5. The computer-implemented method of claim 1, further comprising, prior to receiving, by the mobile computing device, the data descriptive of the input stroke pattern entered by the user:
receiving, by the mobile computing device, a user command to enter a shortcut mode of operation;
wherein said receiving the data descriptive of the input stroke pattern, said identifying the one of the plurality of shorthand stroke patterns as the matched shorthand pattern, and said entering the output text string associated with the matched shorthand pattern are performed in response to said receiving the command to enter the shortcut mode.

6. The computer-implemented method of claim 1, further comprising:
receiving, by the mobile computing device, a user request to create a new shorthand stroke pattern;
receiving, by the mobile computing device, data indicative of the new shorthand stroke pattern;
determining, by the mobile computing device, a new output text string to associate with the new shorthand stroke pattern; and
associating, by the mobile computing device the new output text string with the new shorthand stroke pattern in a memory of the mobile computing device.

7. The computer-implemented method of claim 6, wherein determining, by the mobile computing device, the new output text string to associate with the new shorthand stroke pattern comprises:
determining, by the mobile computing device, whether an existing text string was selected when the user request to create the new shorthand stroke pattern was received;
in response to a determination that an existing text string was selected when the user request to create the new shorthand stroke pattern was received, associating, by the mobile computing device, the selected existing text string with the new shorthand stroke pattern; and
in response to a determination that an existing text string was not selected when the user request to create the new shorthand stroke pattern was received, prompting, by the mobile computing device, the user to enter or select the new output text string to associate with the new shorthand stroke pattern.

8. The computer-implemented method of claim 6, further comprising:
using, by at least one of the mobile computing device or a server computing device, the data indicative of the new shorthand stroke pattern to train a shorthand pattern recognizer of the mobile computing device to recognize the new shorthand stroke pattern.

9. The computer-implemented method of claim 1, further comprising:
analyzing, by the mobile computing device, user entered text to identify one or more commonly entered text strings; and
suggesting, by the mobile computing device, that the user associate one of the one or more commonly entered text strings with a new shorthand stroke pattern.

10. A mobile computing device that enables text entry through shorthand stroke patterns, the mobile computing device comprising:
at least one processor;
at least one non-transitory computer-readable medium that stores:
data that describes a plurality of shorthand stroke patterns that have previously been defined by a user of the mobile computing device; and
a plurality of output text strings respectively associated with the plurality of shorthand stroke patterns; and
a shorthand pattern recognizer implemented by the at least one processor, the shorthand pattern recognizer configured to:
receive data that describes an input stroke pattern entered by the user; and
identify one of the plurality of shorthand stroke patterns as a matched shorthand stroke pattern to which the input stroke pattern corresponds;
wherein, in response to identification of the matched shorthand stroke pattern by the shorthand pattern recognizer, the mobile computing device is configured to enter the output text string associated with the matched shorthand stroke pattern into a text entry field.

11. The mobile computing device of claim 10, wherein the shorthand pattern recognizer comprises a nearest neighbor classifier that classifies the input stroke pattern into one of a plurality of classes respectively associated with the plurality of shorthand stroke patterns.

12. The mobile computing device of claim 10, wherein:
the shorthand pattern recognizer comprises a neural network that outputs a plurality of confidence scores respectively for the plurality of shorthand stroke patterns, the confidence score for each shorthand stroke pattern descriptive of a confidence that the input stroke pattern corresponds to such shorthand stroke pattern; and
in response to output of the plurality of confidence scores by the neural network, the mobile computing device is select the shorthand stroke pattern that received the largest confidence score as the matched shorthand stroke pattern.

13. The mobile computing device of claim 10, further comprising:
an input recognizer implemented by the at least one processor, the input recognizer comprising:
the shorthand pattern recognizer that outputs at least a first confidence score descriptive of a first confidence that the input stroke pattern corresponds to the matched shorthand stroke pattern; and
a handwritten text recognizer that outputs at least a second confidence score descriptive of a second confidence that the input stroke pattern corresponds to a recognized text string;
wherein the mobile computing device is further configured to:
determine whether the first confidence score is greater than the second confidence score;
in response to a determination that the first confidence score is greater than the second confidence score, enter the output text string associated with the matched shorthand stroke pattern into the text entry field;
in response to a determination that the first confidence score is not greater than the second confidence score, enter the recognized text string into the text entry field.

14. The mobile computing device of claim 10, further comprising:
an input recognizer implemented by the at least one processor, the input recognizer comprising:
the shorthand pattern recognizer;
a handwritten text recognizer; and
a preliminary classifier that preliminarily classifies the input stroke pattern into a first class associated with the plurality of shorthand stroke patterns and a second class associated with handwritten text.

15. The mobile computing device of claim 14, wherein the mobile computing device is configured to:
input the input stroke pattern into the preliminary classifier;
receive an indication of classification of the input stroke pattern into the first class associated with the plurality of shorthand stroke patterns or the second class associated with handwritten text;
in response to classification of the input stroke pattern into the first class:
input the input stroke pattern into the shorthand pattern recognizer; and
receive identification of the matched shorthand stroke pattern as output from the shorthand pattern recognizer; and
in response to classification of the input stroke pattern into the second class:
input the input stroke pattern into the handwritten text recognizer; and
receive from the handwritten text recognizer identification of a recognized text string that the input stroke pattern approximates.

16. The mobile computing device of claim 10, wherein the input stroke pattern comprises one or more strokes that approximate a non-linguistic symbol.

17. The mobile computing device of claim 10, wherein the data that describes the plurality of shorthand stroke patterns that have previously been defined by the user of the mobile computing device comprises data that describes one or more respective features extracted from each of the plurality of shorthand stroke patterns.

18. At least one non-transitory computer-readable medium that stores instructions that, when executed by at least one processor, cause the at least one processor to:
receive data descriptive of an input stroke pattern entered by a user;
input the data descriptive of the input stroke pattern into a shorthand pattern classifier;
receive as output from the shorthand pattern classifier an identification of one of a plurality of shorthand stroke patterns as a matched shorthand pattern to which the input stroke pattern corresponds, the plurality of shorthand stroke patterns previously defined by the user, a plurality of output text strings respectively associated with the plurality of shorthand stroke patterns; and
in response to receiving the identification of the matched shorthand pattern, enter the output text string associated with the matched shorthand pattern into a text entry field.

19. The at least one non-transitory computer-readable medium of claim 18, wherein the shorthand pattern classifier comprises a neural network classifier or a nearest neighbor classifier.

20. The at least one non-transitory computer-readable medium of claim 18, wherein the input stroke pattern comprises one or more strokes that approximate a non-linguistic symbol.
